(19) United States
(12) Patent Application Publication
(10) Pub. No.: US 2024/0387072 A1
(43) Pub. Date: Nov. 21, 2024

(54) WIRE HARNESS

(71) Applicant: YAZAKI CORPORATION, Tokyo (JP)

(72) Inventors: Kimiaki Nakajima, Toyota-shi (JP); Makoto Goto, Toyota-shi (JP)

(21) Appl. No.: 18/663,028

(22) Filed: May 13, 2024

(30) Foreign Application Priority Data
May 17, 2023 (JP) 2023-081171
Sep. 25, 2023 (JP) 2023-159956

(51) Int. Cl. H01B 7/00; B60R 16/02

(52) U.S. Cl. CPC H01B 7/0045; B60R 16/0215

(57) ABSTRACT

A wire harness includes: a wire group connecting electrical connectors for each of at least n-1 pairs of electrical connectors; and a pair of exterior members sandwiching all the wire groups, in which the rest of n electrical connectors excluding a pair of main electrical connectors are sub-electrical connectors, one of all wire groups is a main wire group connecting the pair of main electrical connectors, the rest of all the wire groups are sub-wire groups connecting, among at least n-1 pairs of electrical connectors, remaining pairs excluding the pair of main electrical connectors, and at least n-1 pairs of electrical connectors include at least one pair which is a combination of a main electrical connector and a sub-electrical connector connected by a sub-wire group.

### CROSS-REFERENCE TO RELATED APPLICATION(S)

The present application claims priority to and incorporates by reference the entire contents of Japanese Patent Application No. 2023-081171 filed in Japan on May 17, 2023 and Japanese Patent Application No. 2023-159956 filed in Japan on Sep. 25, 2023.

### BACKGROUND OF THE INVENTION

### 1. Field of the Invention

The present invention relates to a wire harness.

### 2. Description of the Related Art

Conventionally, there are known wire harnesses including n (n=a natural number greater than or equal to 3) electrical connectors (connectors and the like) and wire groups mutually connecting paired electrical connectors for each of at least n−1 pairs of electrical connectors of the n electrical connectors. This type of wire harness is disclosed in, for example, Japanese Patent Application Laid-open No. 2022-185353 A.

Meanwhile, a conventional wire harness includes a first wire group that connects a first electrical connector and a second electrical connector, a second wire group that connects the first electrical connector and a third electrical connector, and a third wire group that connects the second electrical connector and the third electrical connector. Moreover, the third electrical connector is disposed in a direction intersecting an axis of the first wire group with respect to the first wire group connecting the first electrical connector and the second electrical connector in the shortest path. In this wire harness, for example, the second wire group is made to extend in parallel with the first wire group from the first electrical connector, and the second wire group is bent at a branching portion in the middle of the first wire group and directed towards the third electrical connector. Furthermore, in the wire harness, for example, the third wire group is made to extend in parallel with the first wire group from the second electrical connector, and the third wire group is bent at a branching portion in the middle of the first wire group and directed towards the third electrical connector. In this conventional wire harness, since the second wire group and the third wire group are routed in the paths passing through the branching portion, the path lengths thereof are longer than the distance between the first electrical connector and the third electrical connector or the distance between the second electrical connector and the third electrical connector. For the wire groups, the longer the path length is, the higher the material cost is required. In addition, in this conventional wire harness, for example, an adhesive tape is wound around branching portions of the first wire group, the second wire group, and the third wire group, or the branching portions of the first wire group, the second wire group, and the third wire group are bundled by a clamp, whereby the first wire group, the second wire group, and the third wire group are prevented from scattering at the branching portions. In this case, the material cost of the adhesive tape or the clamp and the work cost of winding the adhesive tape are required.

### SUMMARY OF THE INVENTION

Therefore, an object of the present invention is to provide a wire harness which can reduce the cost.

In order to achieve the above mentioned object, a wire harness according to one aspect of the present invention includes n (n=a natural number greater than or equal to 3) electrical connectors, at least n−1 pairs of which, obtained by combining two electrical connectors using all the n electrical connectors, are set as wire connection targets; a wire group including a plurality of wires, the wire group mutually connecting a pair of the electrical connectors for each of the at least n−1 pairs of the electrical connectors set as the wire connection targets; and a pair of exterior members sandwiching and accommodating all the wire groups inside the exterior members, the exterior members having a sheet-like shape and being insulating, wherein one of the at least n−1 pairs of the electrical connectors set as the wire connection targets is a pair of main electrical connectors arranged with a space between the main electrical connectors, remaining electrical connectors, excluding the pair of the main electrical connectors, out of the n electrical connectors, are sub-electrical connectors arranged at intervals in an intersecting direction intersecting a straight line connecting the pair of the main electrical connectors, one of all the wire groups is a main wire group linearly connecting the pair of the main electrical connectors in a shortest path, and a rest of all the wire groups is a sub-wire group linearly connecting, in a shortest path, among the at least n−1 pairs of the electrical connectors set as the wire connection targets, a remaining pair excluding the pair of the main electrical connectors, and the at least n−1 pairs of the electrical connectors set as the wire connection targets include at least one pair which is a combination of the main electrical connector and the sub-electrical connector connected by the sub-wire group.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram for explaining a wire harness (n=3) according to an embodiment;

FIG. 2 is a cross-sectional view taken along line X1-X1 in FIG. 1;

FIG. 3 is an explanatory diagram for explaining a wire harness (n=4) of the embodiment;

FIG. 4 is a cross-sectional view taken along line X2-X2 in FIG. 3;

FIG. 5 is an explanatory diagram for explaining a first exterior installation step;

FIG. 6 is an explanatory diagram for explaining the first exterior installation step and is rotated by 90 degrees such that a jig plate is positioned vertically downward as viewed in a direction indicated by an arrow A in FIG. 5;

FIG. 7 is an explanatory diagram for explaining a wire installation step;

FIG. 8 is an explanatory diagram for explaining a wire holding step;

FIG. 9 is a cross-sectional view taken along line X3-X3 in FIG. 8;

FIG. 10 is an explanatory diagram for explaining a second exterior installation step;

FIG. 11 is an explanatory diagram for explaining an installation example in a vehicle;

FIG. 12 is a cross-sectional view taken along line X2-X2 in FIG. 11;

FIG. 13 is an explanatory diagram for explaining a wire harness (n=4) of a modification;

FIG. 14 is a perspective view schematically illustrating an overview of the wire harness (n=4) of the modification;

FIG. 15 is an exploded perspective view schematically illustrating the overview of the wire harness (n=4) of the modification;

FIG. 16 is an explanatory diagram for explaining a first exterior installation step of the modification;

FIG. 17 is an explanatory diagram for explaining a wire installation step of the modification;

FIG. 18 is an explanatory diagram for explaining a second exterior installation step of the modification; and

FIG. 19 is an explanatory diagram for explaining an installation example of the wire harness of the modification on a vehicle.

### DETAILED DESCRIPTION OF THE PREFERRED EMBODIMENTS

Hereinafter, embodiments of a wire harness according to the present invention will be described in detail with reference to the drawings. Note that the invention is not limited by the embodiments.

### Embodiments

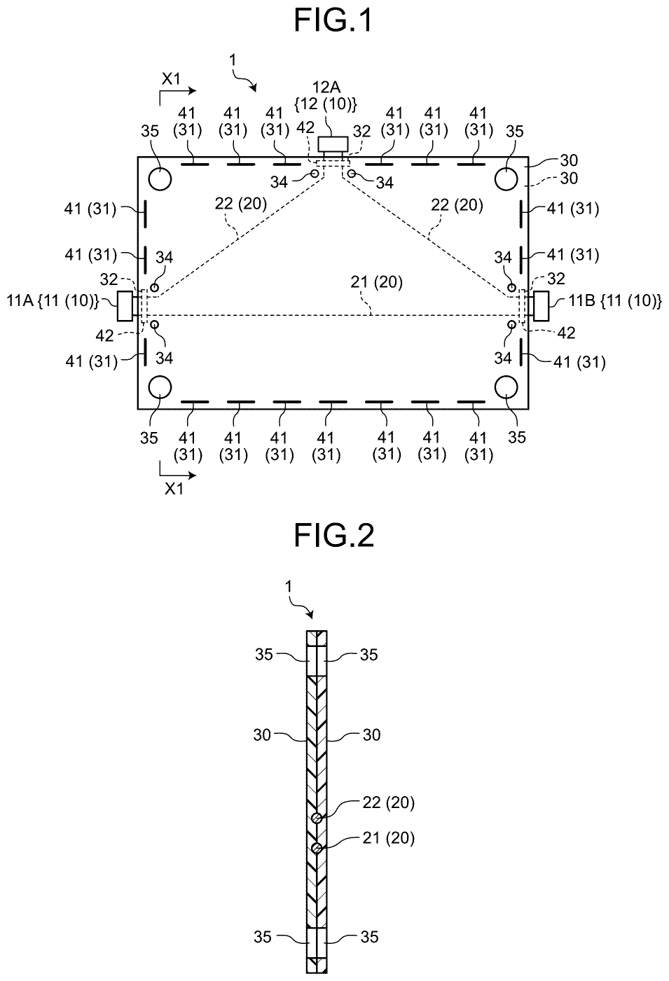

One embodiment of a wire harness according to the present invention will be described with reference to FIGS. 1 to 12.

Reference numeral 1 in FIGS. 1 to 4 indicates a wire harness of the present embodiment.

The wire harness 1 includes n (n=a natural number greater than or equal to 3) electrical connectors 10, at least n−1 pairs of which, obtained by combining two electrical connectors using all the n electrical connectors 10, are set as wire connection targets (FIGS. 1 to 4). An electrical connector 10 is, for example, a connector, and is physically and electrically connected to a mating connector of an electric device, a mating connector of a terminal of a wire group, or the like. In the wire harness 1, at least n−1 pairs of electrical connectors 10 are paired when each two electrical connectors are paired using all the n electrical connectors 10. Therefore, in the wire harness 1, at least n−1 combinations are set as objects to be connected by wires (wire connection targets).

Here, for convenience of description, the n electrical connectors 10 are roughly classified into a pair of main electrical connectors 11 and all the remaining sub-electrical connectors 12 as follows.

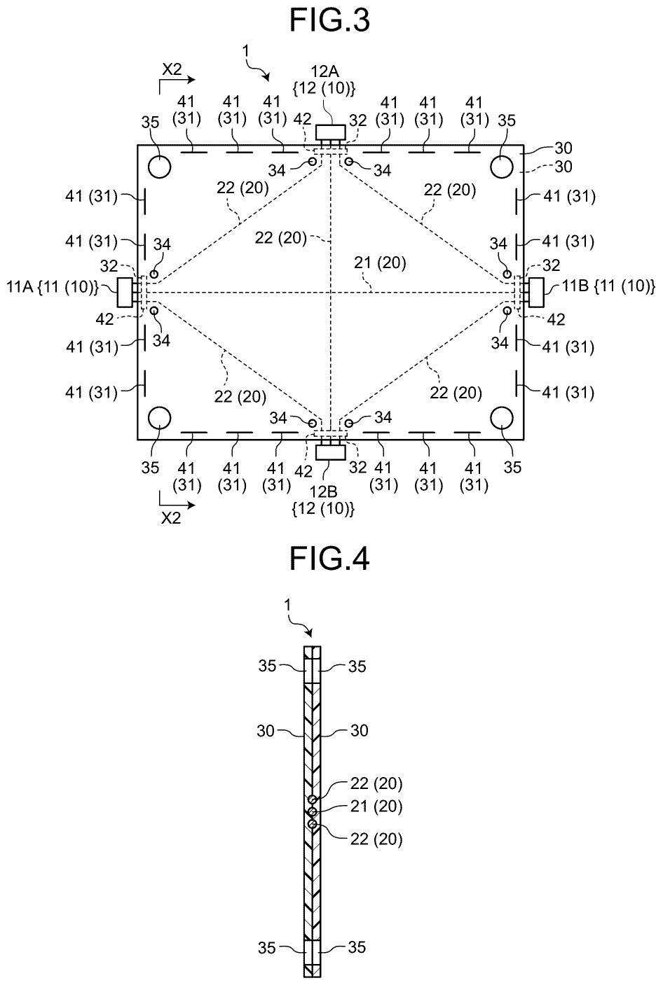

One of at least n−1 pairs of electrical connectors 10 set as wire connection targets is a pair of the main electrical connectors 11 (a first main electrical connector 11A and a second main electrical connector 11B) arranged with a space therebetween (FIGS. 1 and 3). That is, the n electrical connectors 10 include the pair of main electrical connectors 11 (the first main electrical connector 11A and the second main electrical connector 11B). The remaining electrical connectors, excluding the pair of main electrical connectors 11 (the first main electrical connector 11A and the second main electrical connector 11B), out of the n electrical connectors 10 are sub-electrical connectors 12 arranged at intervals in a direction intersecting a straight line connecting the pair of main electrical connectors 11 (the first main electrical connector 11A and the second main electrical connector 11B) (FIGS. 1 and 3).

Note that, regardless of whether the number of the sub-electrical connectors 12 included in the n electrical connectors 10 is singular or plural, at least n−1 pairs of electrical connectors 10 set as wire connection targets include at least one pair that is a combination of a main electrical connector 11 and a sub-electrical connector 12 (FIGS. 1 and 3).

In addition, in a case where the number of sub-electrical connectors 12 included in the n electrical connectors 10 is plural, at least one pair of sub-electrical connectors 12 may be included in the at least n−1 pairs of electrical connectors 10 set as wire connection targets under the following condition (FIG. 3). The condition is to include at least one first sub-electrical connector 12 disposed with a space on one side in a direction intersecting the straight line connecting the pair of main electrical connectors 11 (the first main electrical connector 11A and the second main electrical connector 11B) and at least one second sub-electrical connector 12 disposed with a space on the other side in the direction intersecting the straight line.

For example, in a case where there are three electrical connectors 10 (n=3), a pair of main electrical connectors 11 (the first main electrical connector 11A and the second main electrical connector 11B) and one sub-electrical connector 12 are included (FIGS. 1 and 2). In this case, at least two pairs of electrical connectors 10 set as wire connection targets are paired, and at most three pairs of electrical connectors 10 set as wire connection targets are paired. One of the at least two pairs of electrical connectors 10 set as wire connection targets is a combination of the main electrical connectors 11 (the first main electrical connector 11A and the second main electrical connector 11B), and the rest is at least one of a combination of the first main electrical connector 11A and the sub-electrical connector 12 or a combination of the second main electrical connector 11B and the sub-electrical connector 12.

Meanwhile, for example, in a case where there are four electrical connectors 10 (n=4), a pair of main electrical connectors 11 (first main electrical connector 11A and second main electrical connector 11B) and two sub-electrical connectors 12 (first sub-electrical connector 12A and second sub-electrical connector 12B) are included (FIGS. 3 and 4). In this case, at least three pairs of electrical connectors 10 set as wire connection targets are obtained, and at most six pairs of electrical connectors 10 set as wire connection targets are obtained. One of at least three pairs of electrical connectors 10 set as wire connection targets is a pair of the main electrical connectors 11 (the first main electrical connector 11A and the second main electrical connector 11B). The rest of the at least three pairs of electrical connectors 10 set as wire connection targets may be at least two pairs, which is a combination of a main electrical connector 11 and a sub-electrical connector 12, only or a mixture of at least one pair, which is a combination of a main electrical connector 11 and a sub-electrical connector 12, and a combination of two sub-electrical connectors 12 (the first sub-electrical connector 12A and the second sub-electrical connector 12B). In this case, the at least one pair, which is a combination of a main electrical connector 11 and a sub-electrical connector 12 set as wire connection targets, refers to at least one of a combination of the first main electrical connector 11A and a first sub-electrical connector 12 (the first sub-electrical connector 12A), a combination of the first main electrical connector 11A and a second sub-electrical connector 12 (the second sub-electrical connector 12B), a combination of the second main electrical connector 11B and the first sub-electrical connector 12 (the first sub-electrical connector 12A), or a combination of the second main electrical connector 11B and the second sub-electrical connector 12 (the second sub-electrical connector 12B).

The wire harness 1 includes a wire group 20 that includes a plurality of wires and mutually connects paired electrical connectors 10 for each of at least n−1 pairs of electrical connectors 10 set as wire connection targets (FIGS. 1 and 3). In the wire group 20, a plurality of wires are bundled together.

One of all the wire groups 20 is a main wire group 21 linearly connecting the pair of main electrical connectors 11 (the first main electrical connector 11A and the second main electrical connector 11B) in the shortest path (FIGS. 1 and 3). The rest of all the wire groups 20 are sub-wire groups 22 that linearly connect, in the shortest path, among the at least n−1 pairs of electrical connectors 10 set as wire connection targets, the remaining pairs excluding the pair of main electrical connectors 11 (the first main electrical connector 11A and the second main electrical connector 11B) (FIGS. 1 and 3). The combinations of a main electrical connector 11 and a sub-electrical connector 12 described above are connected by the sub-wire groups 22 (FIGS. 1 and 3). Furthermore, the pair of sub-electrical connectors 12 (the first sub-electrical connector 12A and the second sub-electrical connector 12B) described above is connected by a sub-wire group 22 (FIG. 3).

The wire harness 1 having three (n=3) electrical connectors 10 exemplified herein includes the main wire group 21 linearly connecting the pair of main electrical connectors 11 (the first main electrical connector 11A and the second main electrical connector 11B) by the shortest path, the sub-wire group 22 linearly connecting the combination of the first main electrical connector 11A and a sub-electrical connector 12 by the shortest path, and the sub-wire group 22 linearly connecting the combination of the second main electrical connector 11B and a sub-electrical connector 12 by a shortest path (FIG. 1).

Likewise, the wire harness 1 having four (n=4) electrical connectors 10 exemplified here includes the main wire group 21 that linearly connects the pair of main electrical connectors 11 (the first main electrical connector 11A and the second main electrical connector 11B) by the shortest path, the sub-wire group 22 that linearly connects the combination of the first main electrical connector 11A and the first sub-electrical connector 12A by the shortest path, the sub-wire group 22 that linearly connects the combination of the first main electrical connector 11A and the second sub-electrical connector 12B by the shortest path, the sub-wire group 22 that linearly connects the combination of the second main electrical connector 11B and the first sub-electrical connector 12A by the shortest path, the sub-wire group 22 that linearly connects the combination of the second main electrical connector 11B and the second sub-electrical connector 12B by the shortest path, and the sub-wire group 22 linearly connecting the combination of the first sub-electrical connector 12A and the second sub-electrical connector 12B in the shortest path (FIG. 3).

The wire harness 1 includes a pair of sheet-like insulating exterior members 30 that sandwiches and accommodates all the wire groups 20 therein (FIGS. 1 to 4).

The pair of exterior members 30 has joint portions 31 which are joined in contact with each other (FIGS. 1 and 3). The joint portions 31 may be formed by welding the pair of exterior members 30 to each other or may be formed by joining the pair of exterior members 30 by fixing members (hereinafter, referred to as “exterior fixing members”) 41 (FIGS. 1 and 3). In a case where the pair of exterior members 30 is welded and joined, the pair of exterior members is molded with an insulating raw material that enables the welding. The exterior members 30 in this case are molded using, for example, vinyl chloride, polyvinyl chloride, polyamide, or the like as a raw material and are welded using well-known welding technology such as high-frequency welding or ultrasonic welding. Alternatively, in the case where the pair of exterior members 30 is joined by the exterior fixing member 41, the pair of exterior members is molded with an insulating raw material adequate for the form of the exterior fixing members 41. In this example, the pair of exterior members 30 is joined at a plurality of locations by stapler needles as the exterior fixing members 41 and is molded using a raw material (for example, vinyl chloride or the like) through which the needles can penetrate. The pair of exterior members 30 may be different members or may be the same member. The exterior members 30 may be flexible.

A wire outlet 32, through which a wire group 20 inside is drawn out, is formed between the pair of exterior members 30 for each electrical connector 10 (FIGS. 1 and 3). The wire outlet 32 allows at least one wire group 20 to be drawn out from the inside to the outside. The wire group 20 is connected to the electrical connector 10 at a point where the wire group is drawn out from the wire outlet 32.

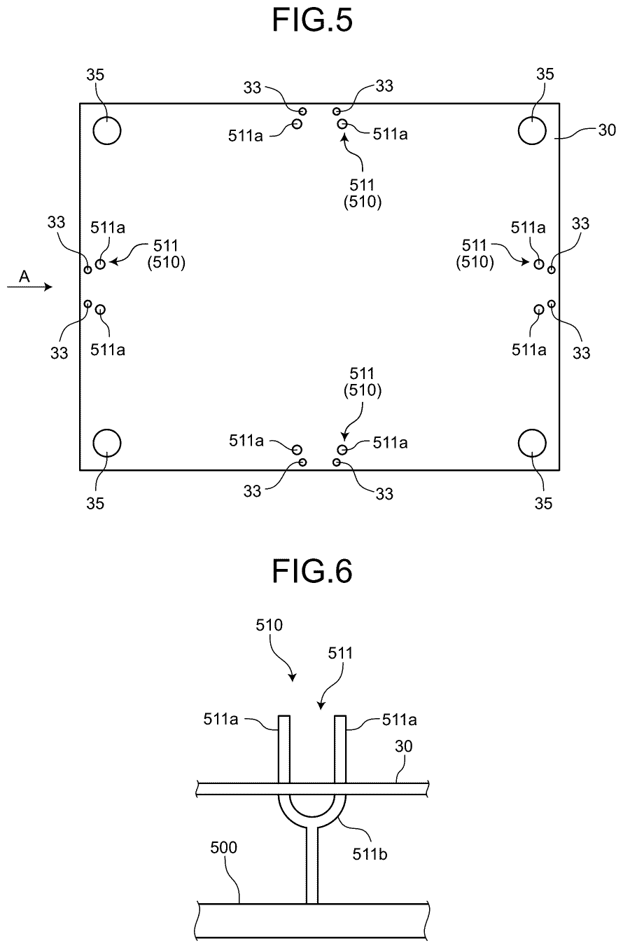

The wire harness 1 includes a fixing member (hereinafter, referred to as a “wire fixing member”) 42 that fixes all the wire groups 20, drawn out from a common wire outlet 32, to an exterior member 30 at the wire outlet 32 (FIGS. 1 and 3). The wire fixing member 42 is, for example, a cable tie and bundles all the wire groups 20 drawn out from the common wire outlet 32 together and fixes them to first one of the pair of exterior members 30. In this case, two through-holes (hereinafter, referred to as “wire fixing holes”) 33 through which the wire fixing member 42 is inserted are formed in the first exterior member 30 (FIG. 5).

The wire harness 1 is assembled on a jig plate 500 by the following manufacturing method (FIG. 6).

The manufacturing method of the wire harness 1 includes a first exterior installation step of causing a support member 510 installed on the jig plate 500 to support the first exterior member 30 (FIGS. 5 and 6).

The support member 510 has a support portion 511 that supports the first exterior member 30 and is erected on the jig plate 500 (FIGS. 5 and 6). The support portion 511 includes at least two support pins 511a arranged to face each other with a space therebetween and a coupling portion 511b that couples first ends of the at least two support pins 511a (FIGS. 5 and 6). The support portion 511 exemplified here is formed in a U shape by the two support pins 511a and the coupling portion 511b.

The support member 510 is prepared for each wire outlet 32 formed when the pair of exterior members 30 is joined and supports the first exterior member 30 at a place formed as the wire outlet 32. Therefore, in the first exterior member 30, a through-hole (hereinafter, referred to as an “exterior support hole”) 34 through which a support pin 511a is inserted is formed for each support pin 511a at a place formed as a wire outlet 32 (FIGS. 1 and 3). In the first exterior member 30, two wire fixing holes 33 are formed on an inner side with respect to a place to be an opening end of a wire outlet 32, and an exterior support hole 34 for each support pin 511a is formed on a further inner side with respect to the two wire fixing holes 33. The exterior support hole 34 for each support pin 511a is formed at a place formed as a wire outlet 32 also in the second exterior member 30.

In the first exterior installation step, when the first exterior member 30 is installed on the jig plate 500, support pins 511a are inserted into exterior support holes 34 from tips for each of the support portions 511 of the support members 510, whereby the first exterior member 30 is supported on the coupling portions 511b side of the support portions 511. For example, in the case where the number of electrical connectors 10 is four (n=4), in the first exterior installation step, support pins 511a are inserted into exterior support holes 34 of the first exterior member 30 from the tips for each of the support portions 511 of the support members 510 at the four locations (FIG. 5).

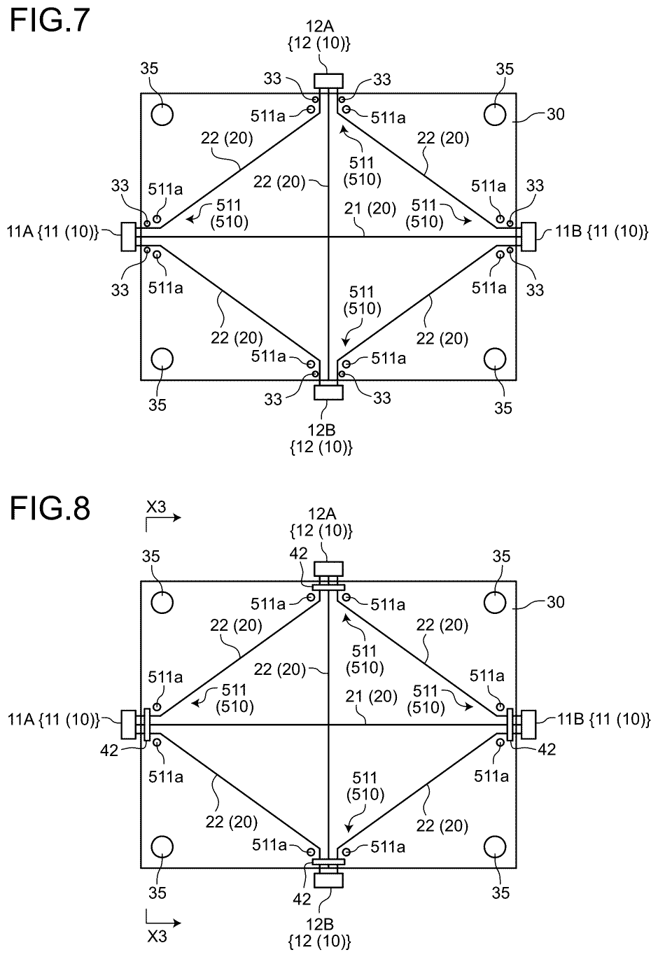

This manufacturing method includes a wire installation step of placing all the wire groups 20 on the first exterior member 30 (FIG. 7).

In the wire installation step, a wire group 20, passing through a wire outlet 32 corresponding to a support member 510, is inserted and installed between two support pins 511a for each of the support portions 511 of the support members 510 (FIG. 7). In this wire installation step, when a wire group 20 is installed, the wire group 20 is linearly routed in such a manner as to pass through the shortest path between two support members 510 (FIG. 7). For example, in the case where there are four electrical connectors 10 (n=4), in the wire installation step, the main wire group 21 that linearly connects the pair of main electrical connectors 11 (the first main electrical connector 11A and the second main electrical connector 11B) by the shortest path, the sub-wire group 22 that linearly connects a combination of the first main electrical connector 11A and the first sub-electrical connector 12A by the shortest path, the sub-wire group 22 that linearly connects a combination of the first main electrical connector 11A and the second sub-electrical connector 12B by the shortest path, the sub-wire group 22 that linearly connects a combination of the second main electrical connector 11B and the first sub-electrical connector 12A by the shortest path, and the sub-wire group 22 that linearly connects a combination of the second main electrical connector 11B and the second sub-electrical connector 12B by the shortest path, and the sub-wire group 22 linearly connecting a combination of the first sub-electrical connector 12A and the second sub-electrical connector 12B by the shortest path are separately routed.

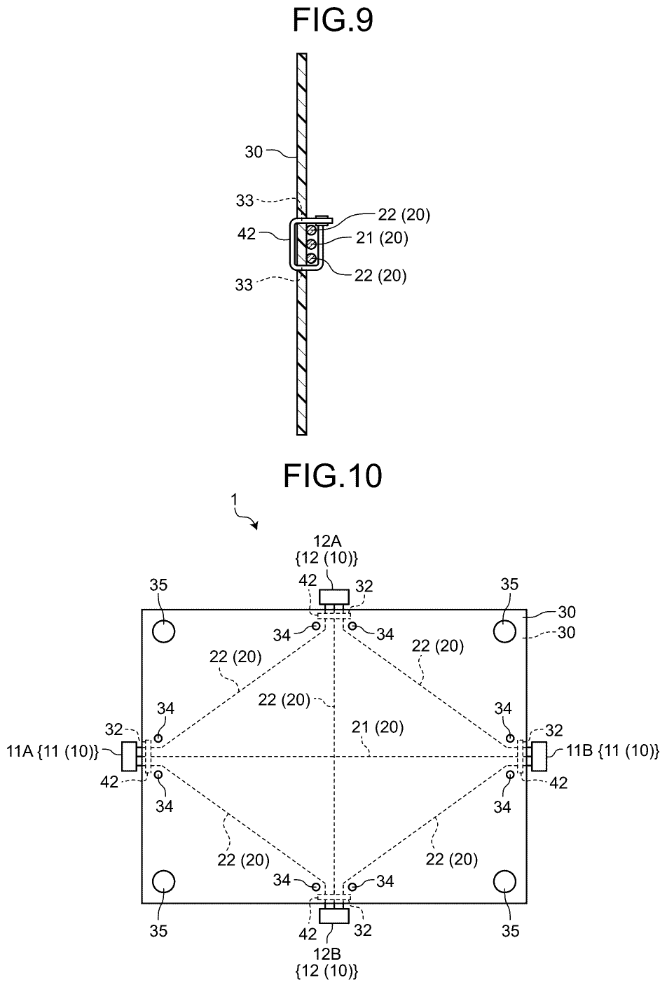

This manufacturing method includes a wire holding step of fixing, for each of the support portions 511 of the support members 510, all the wire groups 20 supported by the support portion 511 to the first exterior member 30 (FIGS. 8 and 9).

In this wire holding step, for example, for each of the support portions 511, a cable tie as the wire fixing member 42 is sequentially inserted into the two wire fixing holes 33 in the first exterior member 30 from the tip, and the wire fixing member 42 is wound around all the wire groups 20 supported by the first exterior member 30 and the support portion 511 (FIGS. 8 and 9). For example, in a case where the number of the electrical connectors 10 is four (n=4), in the wire holding step, the first exterior member 30 and the wire group 20 are fixed by the wire fixing member 42 for each of the support portions 511 of the support members 510 at the four locations.

This manufacturing method includes a second exterior installation step of placing a second exterior member 30 on the first exterior member 30 and all the wire groups 20 and sandwiching all the wire groups 20 between the first exterior member 30 and the second exterior member 30 (FIG. 10).

In the second exterior installation step, the second exterior member 30 is installed by inserting support pins 511a into exterior support holes 34 from the tips for each of the support portions 511 of the support members 510 (FIG. 10). For example, in the case where the number of electrical connectors 10 is four (n=4), in the second exterior installation step, support pins 511a are inserted into exterior support holes 34 of the second exterior member 30 from the tips for each of the support portions 511 of the support members 510 at the four locations.

This manufacturing method includes an exteriors joining step of joining the pair of exterior members 30 (FIG. 3).

In this exteriors joining step, the outer peripheral edges of the pair of exterior members 30 are fixed at a plurality of locations by stapler needles as the exterior fixing members 41 (FIG. 3). For example, in a case where the number of the electrical connectors 10 is four (n=4), in the exteriors joining step, the outer peripheral edges of the pair of exterior members 30 between the first main electrical connector 11A side and the first sub-electrical connector 12A side, the outer peripheral edges of the pair of exterior members 30 between the first main electrical connector 11A side and the second sub-electrical connector 12B side, the outer peripheral edges of the pair of exterior members 30 between the second main electrical connector 11B side and the first sub-electrical connector 12A side, and the outer peripheral edges of the pair of exterior members 30 between the second main electrical connector 11B side and the second sub-electrical connector 12B side are fixed by the exterior fixing members 41.

In the wire harness 1 of the present embodiment described above, for combinations of all pairs of electrical connectors 10 set as wire connection targets, a pair of electrical connectors 10 is linearly connected by a wire group 20 in the shortest path. Therefore, the wire harness 1 can keep the material cost of the wire groups 20 low, thereby achieving a cost reduction. Furthermore, in the wire harness 1, with all the wire groups 20 linearly routed in the shortest paths, all the wire groups 20 are sandwiched and fixed between the pair of exterior members 30. Therefore, in this wire harness 1, since no branching portions of the wire groups 20, as those in the related art, are formed, no adhesive tapes nor a clamp for bundling the wire groups 20 at branching portions are required, and thus, it is possible to reduce the cost also in this respect.

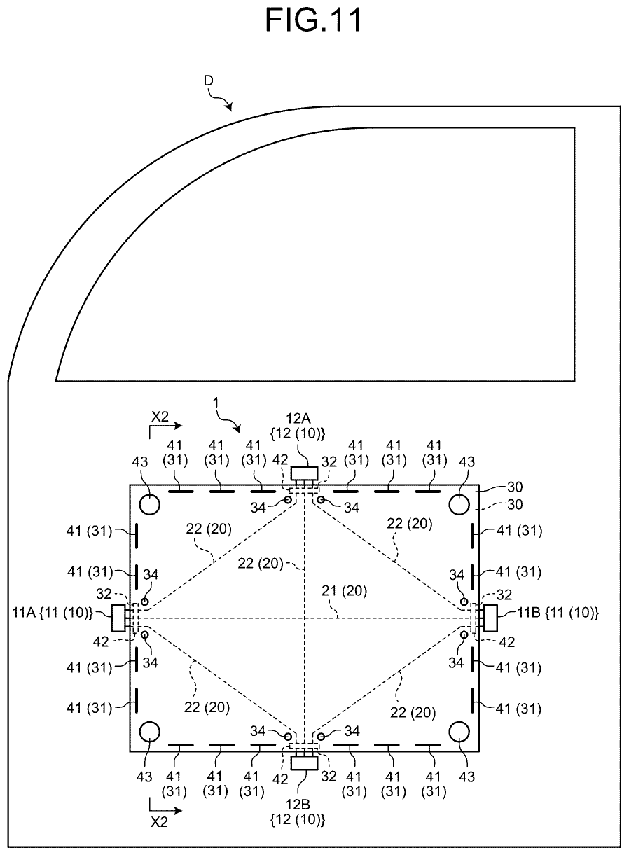

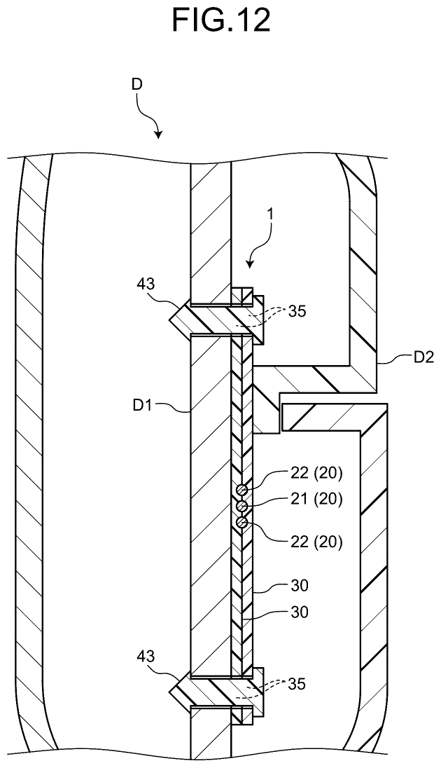

Meanwhile, the wire harness 1 is used for a structure such as a vehicle body (such as a floor panel, a dash panel, or a roof panel) or a door in a vehicle deemed as a routing target, is routed along the routing target, and is fixed to the routing target. Therefore, the wire harness 1 includes at least one fixing member (hereinafter, referred to as a “harness fixing member”) 43 that fixes the pair of exterior members 30 to the routing target (FIGS. 11 and 12). The pair of exterior members 30 has a through-hole (hereinafter, referred to as an “insertion hole”) 35 through which the harness fixing member 43 is inserted for each harness fixing member 43 (FIGS. 1, 3, 5, 7, 8, 10, and 12). The insertion hole 35 allows the pair of exterior members 30 to be fixed to the routing target by clamping the peripheral edge of the through-hole by the harness fixing member 43 and the routing target. For example, a so-called anchor type clip is used as the harness fixing member 43. In this example, a door D is set as the routing target.

The pair of exterior members 30 has insertion holes 35 at a plurality of locations, and a harness fixing member 43 is inserted into each of the insertion holes 35 at the plurality of locations. The pair of exterior members 30 is fixed to the routing target by the harness fixing members 43 at the plurality of locations. In a conventional wire harness, since a clip or the like assembled to a predetermined portion of a wire group is inserted into and fixed to a routing target, it is difficult to maintain the shape of the wire group at the time of assembling the clip or the like to the routing target. On the other hand, in the wire harness 1 of the present embodiment, for example, by molding the exterior members 30 to have the minimum hardness capable of maintaining the shape, the assembling workability of the harness fixing member 43 to the routing target is higher than that in the conventional case. Therefore, the wire harness 1 of the present embodiment can shorten the work time for assembling to a routing target.

On the other hand, when the pair of exterior members 30 is fixed to the routing target by the harness fixing members 43 at the plurality of locations, the outer wall surface of the first exterior member 30 may be brought into contact with the outer wall surface of the routing target. In this case, in the wire harness 1, it is desirable to enhance the adhesion between the outer wall surface of the first exterior member 30 and the outer wall surface of the routing target by imparting flexibility to the pair of exterior members 30. For example, here, an inner panel D1 of the door D is set as the routing target, and the pair of exterior members 30 is fixed to the inner panel D1 by the harness fixing members 43 at the plurality of locations while the outer wall surface of the first exterior member 30 is brought into close contact with a planar portion of the inner panel D1 (FIG. 12). As a result, the wire harness 1 has reduced input from the vehicle body side, and thus transmission of the input to the electrical connector 10 can be suppressed. Therefore, the wire harness 1 can improve its durability. Furthermore, since the wire harness 1 is sandwiched between the inner panel D1 and a door trim D2 while the door trim D2 is brought into close contact with the outer wall surface of the second exterior member 30, and thus transmission of the input from the vehicle body side to the electrical connector 10 can be further suppressed (FIG. 12). Therefore, the wire harness 1 can be further improved in durability.

### Modifications

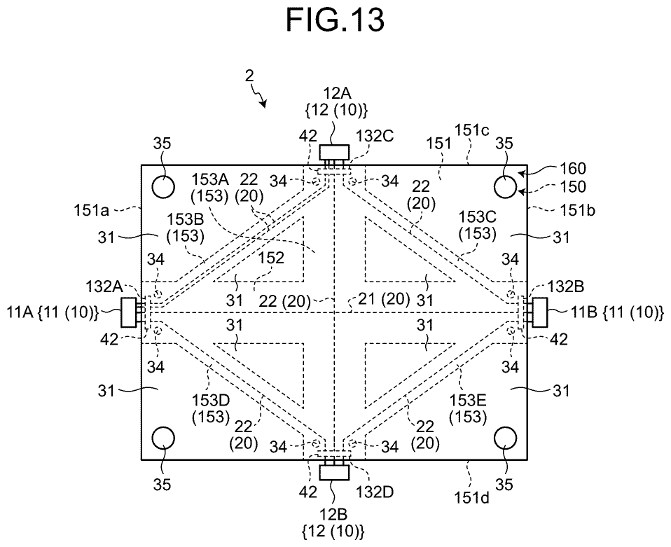

Reference numeral 2 in FIGS. 13 to 15 indicates a wire harness of the present modification. A wire harness 2 of the present modification corresponds to the wire harness 1 of the above-described embodiment in which the pair of exterior members 30 is replaced with a first exterior member 150 and a second exterior member 160. For this reason, in the following description, those denoted by the same reference numerals as those in the embodiment represent the same parts, portions, or the like as those in the embodiment also in the description of the present modification. In addition, description redundant with that of the embodiment will be omitted here.

Similarly to the exterior members 30 of the embodiment, the first exterior member 150 and the second exterior member 160 are molded as sheet-like insulating members.

The first exterior member 150 includes a main body 151 having a flat plate shape, a main wire routing path 152 formed in a groove shape in which a part of the main body 151 is recessed along a routing path of the main wire group 21, the main wire routing path 152 in which the main wire group 21 inserted from a main wire insertion port 152a on the main body 151 side is routed, and sub-wire routing paths 153 formed in a groove shape in which a part of the main body 151 is recessed for each sub-wire group 22 along routing paths of sub-wire groups 22, the sub-wire routing paths in which the sub-wire groups 22 inserted from sub-wire insertion ports 153a on the main body 151 side are routed (FIGS. 13 to 15). In order to maintain such a shape, the first exterior member 150 is molded with an insulating material such as a synthetic resin as a member having this shape.

The main body 151 described here is formed in a rectangular flat plate shape. The main wire routing path 152 is formed in a groove shape linearly connecting a first pair of facing sides (first side 151a and second side 151b) of the main body 151 (FIGS. 13 to 15). Furthermore, the sub-wire routing paths 153 illustrated here includes a first sub-wire routing path 153A linearly connecting a second pair of facing sides (third side 151c and fourth side 151d) in the main body 151, a second sub-wire routing path 153B linearly connecting a first end on the first side 151a side of the main wire routing path 152 and a first end on the third side 151c side of the first sub-wire routing path 153A, a third sub-wire routing path 153C linearly connecting a second end on the second side 151b side of the main wire routing path 152 and the first end of the first sub-wire routing path 153A, a fourth sub-wire routing path 153D linearly connecting the first end of the main wire routing path 152 and a second end on the fourth side 151d side of the first sub-wire routing path 153A, and a fifth sub-wire routing path 153E linearly connecting the second end of the main wire routing path 152 and the second end of the first sub-wire routing path 153A (FIGS. 13 to 15).

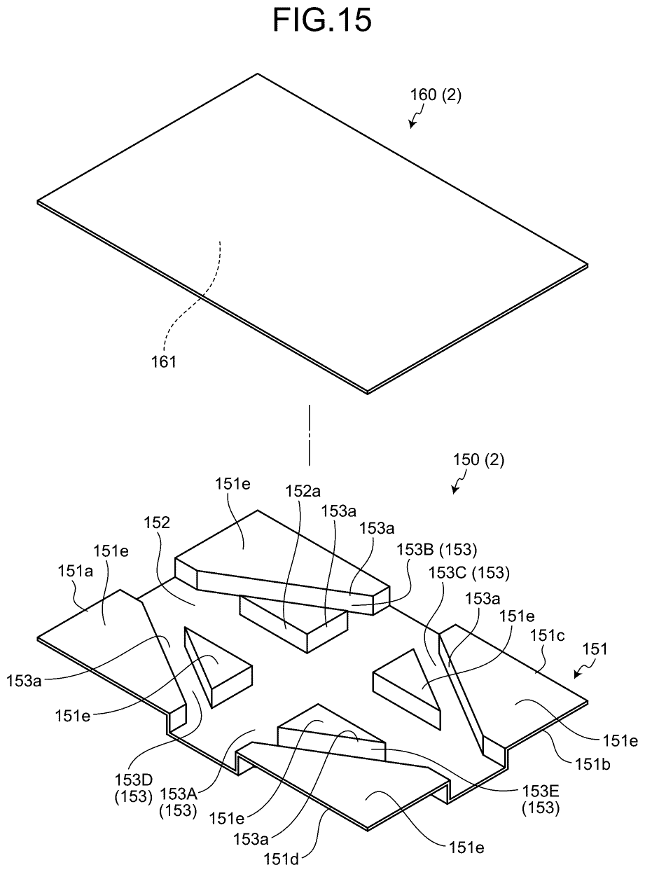

The second exterior member 160 is formed in a flat plate shape (FIGS. 13 to 15). The second exterior member 160 described here is formed in a rectangular flat plate shape. In the main body 151 of the first exterior member 150, there is a plurality of smooth sheet surfaces 151e at places excluding the main wire routing path 152 and the sub-wire routing paths 153 (the first sub-wire routing path 153A, the second sub-wire routing path 153B, the third sub-wire routing path 153C, the fourth sub-wire routing path 153D, and the fifth sub-wire routing path 153E) (FIG. 15). The second exterior member 160 closes the main wire insertion port 152a and sub-wire insertion ports 153a with its own smooth sheet surface 161 (FIG. 15) being in close contact with the sheet surfaces 151e of the main body 151 of the first exterior member 150.

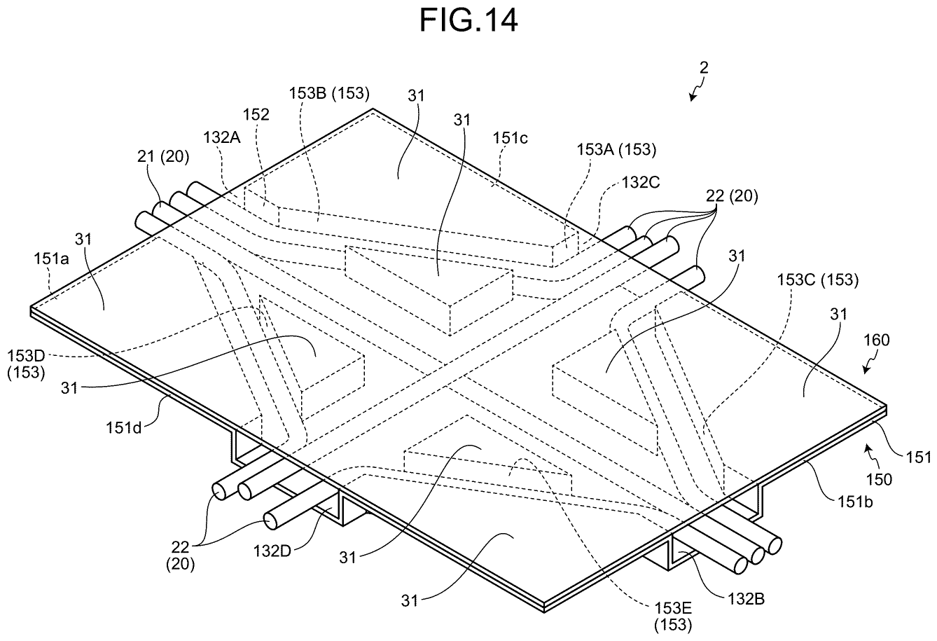

In the first exterior member 150 and the second exterior member 160, the places where the sheet surfaces 151e and the sheet surface 161 are brought into close contact with each other are joined, and each of the places is defined as the joint portion 31 similarly to that in the embodiment (FIGS. 13 and 14). Similarly to the joint portions 31 of the embodiment, the joint portions 31 may be portions formed by welding the first exterior member 150 and the second exterior member 160 or may be portions formed by joining the first exterior member 150 and the second exterior member 160 by exterior fixing members 41. For example, the second exterior member 160 illustrated here is molded as a rectangular film sheet member and is thermocompression-bonded to the first exterior member 150. In this example, the sheet surfaces 151e of the first exterior member 150 and the sheet surface 161 of the second exterior member 160 which are brought into close contact with each other are thermocompression-bonded at each of the places.

In the wire harness 2, between the first end of the main wire routing path 152 and the second exterior member 160, a first main wire outlet 132A is formed (FIGS. 13 and 14) which allows the main wire group 21 of the main wire routing path 152, the sub-wire group 22 of the second sub-wire routing path 153B, and the sub-wire group 22 of the fourth sub-wire routing path 153D to be drawn out to the outside and the main wire group 21 and the sub-wire groups 22 to be coupled to a main electrical connector 11 (first main electrical connector 11A) at a place where the main wire group 21 and the sub-wire groups 22 are drawn out. Likewise, between the second end of the main wire routing path 152 and the second exterior member 160, a second main wire outlet 132B is formed (FIGS. 13 and 14) which allows the main wire group 21 of the main wire routing path 152, the sub-wire group 22 of the third sub-wire routing path 153C, and the sub-wire group 22 of the fifth sub-wire routing path 153E to be drawn out to the outside and the main wire group 21 and the sub-wire groups 22 to be coupled to a main electrical connector 11 (second main electrical connector 11B) at a place where the main wire group 21 and the sub-wire groups 22 are drawn out.

Likewise, between the first end of the first sub-wire routing path 153A and the second exterior member 160, a first sub-wire outlet 132C is formed (FIGS. 13 and 14) which allows the sub-wire group 22 of the first sub-wire routing path 153A, the sub-wire group 22 of the second sub-wire routing path 153B, and the sub-wire group 22 of the third sub-wire routing path 153C to be drawn out to the outside and the sub-wire groups 22 to be coupled to a sub-electrical connector 12 (first sub-electrical connector 12A) at a place where the sub-wire groups 22 are drawn out. Likewise, between the second end of the first sub-wire routing path 153A and the second exterior member 160, a second sub-wire outlet 132D is formed (FIGS. 13 and 14) which allows the sub-wire group 22 of the first sub-wire routing path 153A, the sub-wire group 22 of the fourth sub-wire routing path 153D, and the sub-wire group 22 of the fifth sub-wire routing path 153E to be drawn out to the outside and the sub-wire groups 22 to be coupled to a sub-electrical connector 12 (second sub-electrical connector 12B) at a place where the sub-wire groups 22 are drawn out.

Also in the present modification, a support member 510 is prepared for each wire outlet (the first main wire outlet 132A, the second main wire outlet 132B, the first sub-wire outlet 132C, and the second sub-wire outlet 132D). The support members 510 of the present modification support the first exterior member 150. In the first exterior member 150, exterior support holes 34 for respective support pins 511a are formed at places where wire outlets (the first main wire outlet 132A, the second main wire outlet 132B, the first sub-wire outlet 132C, and the second sub-wire outlet 132D) are formed at the respective groove bottoms of the main wire routing path 152 and the first sub-wire routing path 153A (FIG. 13).

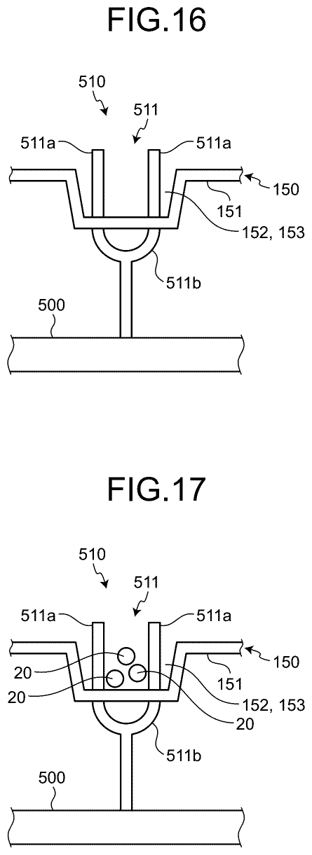

In a first exterior installation step of the modification, support pins 511a are inserted into exterior support holes 34 from tips for each of the support portions 511 of the support members 510, whereby the first exterior member 150 is supported on the coupling portions 511b side of the support portions 511, whereby the first exterior member 150 is installed on a jig plate 500 (FIG. 16). Then, in a wire installation step, the main wire group 21 is inserted from a main wire insertion port 152a and routed in the main wire routing path 152, and the sub-wire groups 22 are inserted from sub-wire insertion ports 153a and routed in the sub-wire routing paths 153 (the first sub-wire routing path 153A, the second sub-wire routing path 153B, the third sub-wire routing path 153C, the fourth sub-wire routing path 153D, and the fifth sub-wire routing path 153E), and the wire groups 20 (the main wire group 21 and the sub-wire groups 22) are inserted between two support pins 511a for each of the support portions 511 of the support members 510 (FIG. 17).

In a wire holding step of the modification, similarly to the wire holding step of the embodiment, a cable tie as the wire fixing member 42 is sequentially inserted into two wire fixing holes (not illustrated) at the respective groove bottoms of the main wire routing path 152 and the first sub-wire routing path 153A from the tip for each of the support portions 511, and the wire fixing member 42 is wound around all the wire groups 20 (the main wire group 21 and the sub-wire groups 22) supported by the first exterior member 150 and the support portion 511.

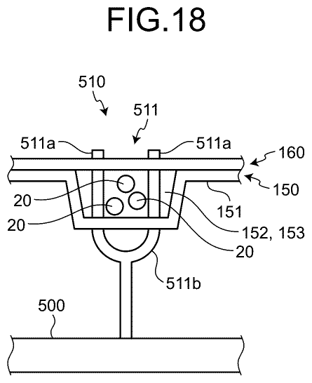

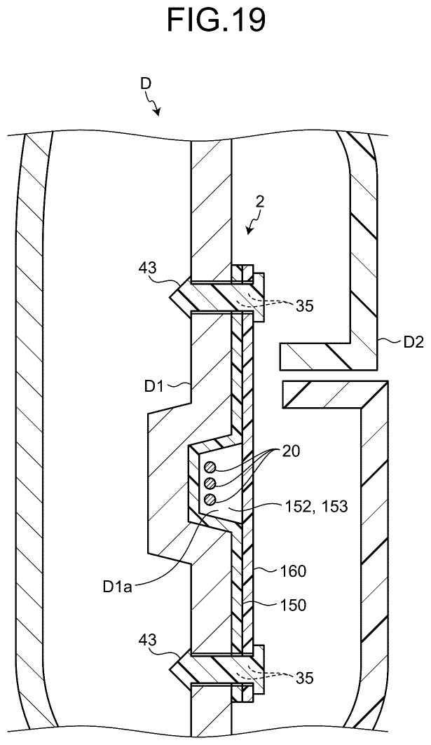

Furthermore, in a second exterior installation step of the modification, the second exterior member 160 is installed on the first exterior member 150 by inserting support pins 511a into exterior support holes 34 of the second exterior member 160 from the tips for each of the support portions 511 of the support members 510 (FIG. 18). Then, in an exteriors joining step of the present modification, the places of the first exterior member 150 and the second exterior member 160 where the sheet surfaces 151e and the sheet surface 161 are brought into close contact with each other are pressurized and heated, and the sheet surfaces 151e and the sheet surface 161 brought into close contact with each other are thermocompression-bonded at each of the places.

Similarly to the wire harness 1 of the embodiment, the wire harness 2 of the present modification sets a structure of a vehicle as a routing target, is routed along the routing target, and is fixed to the routing target. Therefore, similarly to the wire harness 1 of the embodiment, the wire harness 2 of the present modification includes at least one harness fixing member 43, and the insertion hole 35 for each harness fixing member 43 is included in the first exterior member 150 and the second exterior member 160 (FIGS. 13 and 19).

Incidentally, the wire harness 2 of the present modification is fixed to a routing target on which a groove-shaped wire routing path is formed. For example, in this example, groove-shaped wire routing paths D1a are formed in the inner panel D1 of the door D as the routing target (FIG. 19). In the wire harness 2 of the present modification, the main wire routing path 152 and the sub-wire routing paths 153 that can be fitted into the wire routing paths D1a are formed in the first exterior member 150 (FIG. 19). Therefore, in the wire harness 2 of the present modification, the main wire routing paths 152 and the sub-wire routing paths 153 are fitted into the wire routing paths D1a of the inner panel D1, and the first exterior member 150 and the second exterior member 160 are fixed to the inner panel D1 by the harness fixing members 43 at a plurality of locations while the outer wall surface of the first exterior member 150 is made to match a planar portion of the inner panel D1 (FIG. 19).

In the wire harness 2 of the present modification described above, similarly to the wire harness 1 of the embodiment, for combinations of all pairs of electrical connectors 10 set as wire connection targets, a pair of electrical connectors 10 is linearly connected by a wire group 20 in the shortest path. Therefore, the wire harness 2 can keep the material cost of the wire groups 20 low, thereby achieving a cost reduction. Furthermore, in the wire harness 2, with all the wire groups 20 linearly routed in the shortest paths, all the wire groups 20 are sandwiched and fixed between the first exterior member 150 and the second exterior member 160. Therefore, in this wire harness 2, since no branching portions of the wire groups 20, as those in the related art, are formed, no adhesive tapes nor a clamp for bundling the wire groups 20 at branching portions are required, and thus, it is possible to reduce the cost also in this respect.

In a wire harness according to the present embodiment, for combinations of all electrical connectors paired as wire connection targets, a pair of electrical connectors is linearly connected by a wire group in the shortest path. Therefore, the wire harness can keep the material cost of the wire groups low, thereby achieving a cost reduction. Furthermore, in the wire harness, with all the wire groups linearly routed in the shortest paths, all the wire groups are sandwiched and fixed between a pair of exterior members. Therefore, in this wire harness, since no branching portions of the wire groups, as those in the related art, are formed, no adhesive tapes nor a clamp for bundling the wire groups at branching portions are required, and thus, it is possible to reduce the cost also in this respect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
n (n=a natural number greater than or equal to 3) electrical connectors, at least n−1 pairs of which, obtained by combining two electrical connectors using all the n electrical connectors, are set as wire connection targets;
a wire group including a plurality of wires, the wire group mutually connecting a pair of the electrical connectors for each of the at least n−1 pairs of the electrical connectors set as the wire connection targets; and
a pair of exterior members sandwiching and accommodating all the wire groups inside the exterior members, the exterior members having a sheet-like shape and being insulating, wherein
one of the at least n−1 pairs of the electrical connectors set as the wire connection targets is a pair of main electrical connectors arranged with a space between the main electrical connectors,
remaining electrical connectors, excluding the pair of the main electrical connectors, out of the n electrical connectors, are sub-electrical connectors arranged at intervals in an intersecting direction intersecting a straight line connecting the pair of the main electrical connectors,
one of all the wire groups is a main wire group linearly connecting the pair of the main electrical connectors in a shortest path, and a rest of all the wire groups is a sub-wire group linearly connecting, in a shortest path, among the at least n−1 pairs of the electrical connectors set as the wire connection targets, a remaining pair excluding the pair of the main electrical connectors, and
the at least n−1 pairs of the electrical connectors set as the wire connection targets include at least one pair which is a combination of the main electrical connector and the sub-electrical connector connected by the sub-wire group.

2. The wire harness according to claim 1, further comprising:
at least one of the sub-electrical connectors disposed with a space on a first side in the intersecting direction intersecting the straight line; and at least one of the sub-electrical connectors disposed with a space on a second side in the intersecting direction intersecting the straight line, wherein
the at least n−1 pairs of the electrical connectors set as the wire connection targets include at least one pair which is a combination of the sub-electrical connector on the first side and the sub-electrical connector on the second side connected by the sub-wire group.

3. The wire harness according to claim 1, wherein
a wire outlet, through which the wire group inside is drawn out to an outside, is formed between the pair of the exterior members for each of the electrical connectors,
the wire group is connected to the electrical connector at a point where the wire group is drawn out from the wire outlet to the outside, and
the wire harness further comprises a wire fixing member that fixes all the wire groups, drawn out from a common wire outlet to the outside, to the exterior member at the wire outlet.

4. The wire harness according to claim 2, wherein
a wire outlet, through which the wire group inside is drawn out to an outside, is formed between the pair of the exterior members for each of the electrical connectors,
the wire group is connected to the electrical connector at a point where the wire group is drawn out from the wire outlet to the outside, and
the wire harness further comprises a wire fixing member that fixes all the wire groups, drawn out from a common wire outlet to the outside, to the exterior member at the wire outlet.

5. The wire harness according to claim 1, wherein the pair of the exterior members has a joint portion joined in contact with each other.

6. The wire harness according to claim 2, wherein the pair of the exterior members has a joint portion joined in contact with each other.

7. The wire harness according to claim 1, further comprising:
at least one harness fixing member that fixes the pair of the exterior members to a routing target, wherein
the pair of the exterior members includes an insertion hole for each of a plurality of the harness fixing members, the insertion hole being a through-hole through which the harness fixing member is inserted, the insertion hole allowing a peripheral edge of the through-hole to be clamped between the harness fixing member and the routing target.

8. The wire harness according to claim 2, further comprising:
at least one harness fixing member that fixes the pair of the exterior members to a routing target, wherein
the pair of the exterior members includes an insertion hole for each of a plurality of the harness fixing members, the insertion hole being a through-hole through which the harness fixing member is inserted, the insertion hole allowing a peripheral edge of the through-hole to be clamped between the harness fixing member and the routing target.

9. The wire harness according to claim 1, wherein
a first exterior member of the pair of the exterior members includes a main body having a flat plate shape, a main wire routing path formed in a groove shape in which a part of the main body is recessed along a routing path of the main wire group, the main wire group inserted from a main wire insertion port on the main body side being routed in the main wire routing path, and a sub-wire routing path formed in a groove shape in which a part of the main body is recessed for each of the sub-wire groups along routing paths of the sub-wire groups, the sub-wire group inserted from a sub-wire insertion port on the main body side being routed in the sub-wire routing path, and
a second exterior member of the pair of the exterior members is formed in a flat plate shape and closes the main wire insertion port and the sub-wire insertion port with a smooth sheet surface of the second exterior member being in close contact with a sheet surface of the main body of the first exterior member.

10. The wire harness according to claim 2, wherein
a first exterior member of the pair of the exterior members includes a main body having a flat plate shape, a main wire routing path formed in a groove shape in which a part of the main body is recessed along a routing path of the main wire group, the main wire group inserted from a main wire insertion port on the main body side being routed in the main wire routing path, and a sub-wire routing path formed in a groove shape in which a part of the main body is recessed for each of the sub-wire groups along routing paths of the sub-wire groups, the sub-wire group inserted from a sub-wire insertion port on the main body side being routed in the sub-wire routing path, and
a second exterior member of the pair of the exterior members is formed in a flat plate shape and closes the main wire insertion port and the sub-wire insertion port with a smooth sheet surface of the second exterior member being in close contact with a sheet surface of the main body of the first exterior member.

11. The wire harness according to claim 9, wherein the sheet surface of the second exterior member is thermocompression-bonded to the sheet surface of the first exterior member.

12. The wire harness according to claim 10, wherein the sheet surface of the second exterior member is thermocompression-bonded to the sheet surface of the first exterior member.

13. The wire harness according to claim 9, wherein
the main body and the second exterior member are each formed in a rectangular flat plate shape,
the main wire routing path is formed in a groove shape linearly connecting a first pair of facing sides of a first side and a second side in the main body,
the sub-wire routing path includes a first sub-wire routing path linearly connecting a second pair of facing sides of a third side and a fourth side in the main body, a second sub-wire routing path linearly connecting a first end on the first side side of the main wire routing path and a first end on the third side side of the first sub-wire routing path, a third sub-wire routing path linearly connecting a second end on the second side side of the main wire routing path and the first end of the first sub-wire routing path, a fourth sub-wire routing path linearly connecting the first end of the main wire routing path and a second end on the fourth side side of the first sub-wire routing path, and a fifth sub-wire routing path linearly connecting the second end of the main wire routing path and the second end of the first sub-wire routing path,
between the first end of the main wire routing path and the second exterior member, a first main wire outlet is formed, the first main wire outlet allowing the main wire group of the main wire routing path, the sub-wire group of the second sub-wire routing path, and the sub-wire group of the fourth sub-wire routing path to be drawn out to the outside and the main wire group and the sub-wire groups to be coupled to the main electrical connector at a place where the main wire group and the sub-wire groups are drawn out,
between the second end of the main wire routing path and the second exterior member, a second main wire outlet is formed, the second main wire outlet allowing the main wire group of the main wire routing path, the sub-wire group of the third sub-wire routing path, and the sub-wire group of the fifth sub-wire routing path to be drawn out to the outside and the main wire group and the sub-wire groups to be coupled to the main electrical connector at a place where the main wire group and the sub-wire groups are drawn out,
between the first end of the first sub-wire routing path and the second exterior member, a first sub-wire outlet is formed, the first sub-wire outlet allowing the sub-wire group of the first sub-wire routing path, the sub-wire group of the second sub-wire routing path, and the sub-wire group of the third sub-wire routing path to be drawn out to the outside and the sub-wire groups to be coupled to the sub-electrical connector at a place where the sub-wire groups are drawn out, and
between the second end of the first sub-wire routing path and the second exterior member, a second sub-wire outlet is formed, the second sub-wire outlet allowing the sub-wire group of the first sub-wire routing path, the sub-wire group of the fourth sub-wire routing path, and the sub-wire group of the fifth sub-wire routing path to be drawn out to the outside and the sub-wire groups to be coupled to the sub-electrical connector at a place where the sub-wire groups are drawn out.

14. The wire harness according to claim 10, wherein
the main body and the second exterior member are each formed in a rectangular flat plate shape,
the main wire routing path is formed in a groove shape linearly connecting a first pair of facing sides of a first side and a second side in the main body,
the sub-wire routing path includes a first sub-wire routing path linearly connecting a second pair of facing sides of a third side and a fourth side in the main body, a second sub-wire routing path linearly connecting a first end on the first side side of the main wire routing path and a first end on the third side side of the first sub-wire routing path, a third sub-wire routing path linearly connecting a second end on the second side side of the main wire routing path and the first end of the first sub-wire routing path, a fourth sub-wire routing path linearly connecting the first end of the main wire routing path and a second end on the fourth side side of the first sub-wire routing path, and a fifth sub-wire routing path linearly connecting the second end of the main wire routing path and the second end of the first sub-wire routing path,
between the first end of the main wire routing path and the second exterior member, a first main wire outlet is formed, the first main wire outlet allowing the main wire group of the main wire routing path, the sub-wire group of the second sub-wire routing path, and the sub-wire group of the fourth sub-wire routing path to be drawn out to the outside and the main wire group and the sub-wire groups to be coupled to the main electrical connector at a place where the main wire group and the sub-wire groups are drawn out,
between the second end of the main wire routing path and the second exterior member, a second main wire outlet is formed, the second main wire outlet allowing the main wire group of the main wire routing path, the sub-wire group of the third sub-wire routing path, and the sub-wire group of the fifth sub-wire routing path to be drawn out to the outside and the main wire group and the sub-wire groups to be coupled to the main electrical connector at a place where the main wire group and the sub-wire groups are drawn out,
between the first end of the first sub-wire routing path and the second exterior member, a first sub-wire outlet is formed, the first sub-wire outlet allowing the sub-wire group of the first sub-wire routing path, the sub-wire group of the second sub-wire routing path, and the sub-wire group of the third sub-wire routing path to be drawn out to the outside and the sub-wire groups to be coupled to the sub-electrical connector at a place where the sub-wire groups are drawn out, and
between the second end of the first sub-wire routing path and the second exterior member, a second sub-wire outlet is formed, the second sub-wire outlet allowing the sub-wire group of the first sub-wire routing path, the sub-wire group of the fourth sub-wire routing path, and the sub-wire group of the fifth sub-wire routing path to be drawn out to the outside and the sub-wire groups to be coupled to the sub-electrical connector at a place where the sub-wire groups are drawn out.
